(19) United States
(12) Patent Application Publication
(10) Pub. No.: US 2003/0129098 A1
(43) Pub. Date: Jul. 10, 2003

(54) Internal combustion engine exhaust gas purification device

(76) Inventors: Tetsuo Endo, Saitama (JP); Gou Motohashi, Saitama (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/309,319

(22) Filed: Dec. 4, 2002

(30) Foreign Application Priority Data
Dec. 4, 2001 (JP) 2001-370254

(51) Int. Cl. B01D 53/72; B01D 53/94; B01D 53/02

(52) U.S. Cl. 422/171; 422/177

(57) ABSTRACT

An internal combustion engine exhaust gas purification device is provided in which hydrocarbons which are unburned components in an exhaust gas are adsorbed by an adsorbent while a catalyst is in an inactivated state when the internal combustion engine is started, and after the catalyst is activated the HCs desorbed from the adsorbent are converted by the catalyst. Adding to the adsorbent a zeolite on which Cs is supported can increase the HC desorption start temperature of the adsorbent and achieve adequate durability against a high temperature exhaust gas.

### BACKGROUND OF THE INVENTION

1. Field of the Invention

The present invention relates to an internal combustion engine exhaust gas purification device, and more particularly to an improvement of an internal combustion engine exhaust gas purification device in which hydrocarbons (hereinafter called HCs), which are unburned components in an exhaust gas, are adsorbed by an adsorbent while a catalyst is in an inactivated state when the internal combustion engine is started, and after the catalyst is activated the HCs desorbed from the adsorbent are converted by the catalyst.

2. Description of the Related Art

In order to purify an exhaust gas discharged from an internal combustion engine a catalyst is generally used, but since the catalyst is in an inactivated state from the time when the internal combustion engine is started to the time when the temperature of the catalyst reaches an activation temperature (generally around 300° C.), the catalyst cannot purify the exhaust gas. Conventional methods in which HCs in the exhaust gas are adsorbed by an adsorbent until the catalyst is activated, and the HCs desorbed from the adsorbent in response to the temperature of the catalyst becoming high are converted by the catalyst, can be broadly divided into two types.

One of the methods is a bypass switchover method in which, as disclosed in for example Japanese Patent Application Laid-open No. 3-141816, the exhaust gas is made to flow to the adsorbent side by a bypass valve when the internal combustion engine is started, the bypass valve is then switched over so as to make the exhaust gas flow to the catalyst side before the HCs desorb from the adsorbent, the desorbed HCs are converted by a catalyst that is present downstream of the adsorbent, returned to the engine as EGR, or returned to the upstream side of the catalyst to be converted. The other method is an HC adsorption catalyst method in which, as disclosed in for example Japanese Patent Application Laid-open No. 7-213910, a mixture of an adsorbent and a catalyst is supported on a support, or they are supported on a support as layers, the HCs are adsorbed by the adsorption catalyst at a low temperature when the internal combustion engine is started, and when the HCs desorb from the adsorption catalyst at a high temperature they are converted by the catalyst which is present on the same support.

Under current circumstances there is, however, a gap between a desorption start temperature at which the adsorbent starts to release HCs and the temperature at which the catalyst is activated, and the adsorbent releases the majority of the HCs before the catalyst is activated. Therefore, an adsorbent having a higher desorption start temperature is desired.

With regard to the adsorbent for adsorbing the HCs, taking the heat resistance into consideration, zeolites such as aluminosilicates and metallosilicates are generally used. Adsorption on the zeolites involves physical adsorption and chemical adsorption. Since physical adsorption is governed by intermolecular attraction, when a zeolite having a pore size that matches the molecular size of the HCs is used, the intermolecular attraction acts strongly, thereby strengthening the adsorptive power and increasing the desorption temperature of the HCs. However, the exhaust gas contains at least 200 types of HCs having different shapes and sizes, and it is therefore difficult to capture all types of HCs using a single type of zeolite. For this reason, an attempt has been made to combine a large pore size type of zeolite such as a mordenite type, a faujasite type, or a β type, a medium pore size type of zeolite such as an MFI type, and a small pore size type of zeolite such as a ferrierite type or a chabazite type to provide a sufficient adsorption performance for HCs having various molecular sizes. However, it has been difficult to increase the desorption start temperature up to the temperature at which the catalyst is activated by utilizing only physical adsorption on an adsorbent having pore sizes that match the molecular sizes of the HCs.

On the other hand, chemical adsorption is due to bonding between polarities, that is, a polarity caused by ion-exchange, etc. between a metal and an acid in a zeolite, and a polarized HC. It is conventionally known that subjecting a zeolite to an ion-exchange treatment with a metal such as Ag, Pd, or Cu can increase the desorption start temperatures of HCs and, in particular, unsaturated hydrocarbons. Although combining this chemical adsorption with the physical adsorption described above can increase the desorption start temperature, the ion-exchange treatment with a metal decreases the heat resistance, and when it is applied to an environment involving exposure to high temperature and, in particular, to the exhaust gas of an internal combustion engine, the heat resistance is inadequate.

### SUMMARY OF THE INVENTION

The present invention has been carried out in view of the above-mentioned circumstances, and it is an object thereof to provide an internal combustion engine exhaust gas purification device that includes an adsorbent having an increased HC desorption start temperature and having adequate durability against high temperature exhaust gas.

In order to accomplish this object, in accordance with a first aspect of the present invention, there is proposed an internal combustion engine exhaust gas purification device that includes an adsorbent that adsorbs hydrocarbons contained in an exhaust gas from an internal combustion engine, and a catalyst that converts the hydrocarbons desorbed from the adsorbent, wherein the adsorbent contains a zeolite on which Cs is supported.

In accordance with such an arrangement of the first aspect, the chemical adsorption effect of the adsorbent can be enhanced by supporting the Cs on the zeolite. Moreover, when Cs is supported on the zeolite, since Lewis base sites appear thus making the zeolite basic and hydrophobic, the zeolite is less attacked by water at high temperature, thereby making the heat resistance of the zeolite on which Cs is supported superior to that of conventionally known zeolites on which a metal such as Ag, Pd, or Cu is supported, and it becomes possible to increase the HC desorption start temperature of the adsorbent and obtain sufficient durability against high temperature exhaust gas.

With regard to the zeolites on which Cs is supported, there are ZSM-5 and ZSM-11 zeolites having the MFI structure, Y-type and USY-type zeolites having the FAU structure, a mordenite type zeolite having the MOR structure, a β-type zeolite having the BEA structure, a ferrierite type zeolite having the FER structure, etc. Although all types of zeolites give an effect, since they have different heat resistances, a selection can be made according to the required heat resistance temperature that is determined by the displacement of the internal combustion engine, the layout of the adsorbent and the catalyst, etc. In particular, when the required heat resistance temperature is high, a zeolite having the MFI structure is effective since its heat resistance temperature is high.

Furthermore, in accordance with a second aspect of the present invention, in addition to the first aspect, the adsorbent and the catalyst are disposed so that they are not in contact with each other. With this arrangement, it is possible to prevent deterioration of the catalyst at a high temperature due to contact between the catalyst and the Cs.

In order to accomplish the above-mentioned object, in accordance with a third aspect of the present invention, there is proposed an internal combustion engine exhaust gas purification device that includes an adsorbent layer formed by layering on the surface of a support an adsorbent for adsorbing hydrocarbons contained in an exhaust gas from an internal combustion engine, an inorganic material layer formed by layering on top of the adsorbent layer an inorganic material containing no precious metal, and a catalytic layer formed by layering on top of the inorganic material layer a catalyst for converting the hydrocarbons desorbed from the adsorbent, wherein the adsorbent contains a zeolite on which Cs is supported.

In accordance with such an arrangement of the third aspect, when HCs in the exhaust gas are converted by the HC adsorption catalyst method, the presence in the adsorbent of the zeolite on which Cs is supported can enhance the chemical adsorption effect of the adsorbent. Furthermore, when Cs is supported on the zeolite, since Lewis base sites appear thus making the zeolite basic and hydrophobic, attack of the zeolite by water at high temperature is reduced, thereby making the heat resistance of the zeolite on which Cs is supported superior to that of conventionally known zeolites on which a metal such as Ag, Pd, or Cu is supported, and it becomes possible to increase the HC desorption start temperature of the adsorbent and obtain sufficient durability against high temperature exhaust gas. Moreover, since the inorganic material containing no precious metal is present between the adsorbent and the catalyst, it is possible to prevent deterioration of the catalyst at high temperature due to contact between the catalyst and the Cs.

In accordance with a fourth aspect of the present invention, in addition to the third aspect, the zeolite is an MFI-type zeolite. With this arrangement, since the Cs is supported on the MFI-type zeolite which has high heat resistance, higher heat resistance can be achieved.

In accordance with a fifth aspect of the present invention, in addition to the fourth aspect, the inorganic material comprises at least one material chosen from among a β-type zeolite, a Y-type zeolite, and a mordenite type zeolite. With this arrangement, a low adsorptive power of the MFI-type zeolite on which Cs is supported for HCs such as paraffins and olefins having 4 or less carbons, and isooctane and meta-xylene having large molecular sizes, can be compensated for by at least one zeolite chosen from among a β-type zeolite, a Y-type zeolite, and a mordenite type zeolite which have high physical adsorption capability so that the adsorbent layer and the inorganic material layer can provide high adsorptivity and high-temperature retentivity irrespective of the type of HC. In particular, the β-type zeolites have two pore sizes and these pore sizes are advantageously suitable for the molecular sizes of the HCs contained in the xhaust gas of the internal combustion engine.

In accordance with a sixth aspect of the present invention, in addition to the fifth aspect, the catalyst is formed by supporting a precious metal on an inorganic oxide. With this arrangement, the HCs desorbed from the adsorbent can be converted, thereby enhancing the proportion of HCs converted.

### BRIEF DESCRIPTION OF THE DRAWINGS

FIG. 1 is a cross section showing an arrangement of an adsorption catalyst.

FIG. 2 is a graph showing the results of an adsorption/desorption start test on Embodiment 1 and Comparative Examples 1 to 5.

FIG. 3 is a graph showing the results of an adsorption/desorption test on Embodiments 1 and 2 and Comparative Examples 1, 3, and 5.

FIG. 4 is a graph showing the results of measuring the light-off temperature for Embodiments 1 and 3 and Comparative Examples 1 and 6.

FIG. 5 is a graph showing the results of measuring the average proportion converted for Embodiments 1 and 3 and Comparative Examples 1 and 6.

FIG. 6 is a graph showing the results of measuring the change in average proportion converted in response to change in the proportions of the Cs-MFI-type zeolite and the β-type zeolite.

FIG. 7 is a graph showing the results of measuring the change in average proportion converted in response to change in the amount of zeolite.

FIG. 8 is a graph showing the results of measuring the change in average proportion converted in response to change in the amount of catalyst supported.

FIG. 9 is a graph showing the results of measuring the change in average proportion converted in response to change in the amount of precious metal in the catalyst.

FIG. 10 is a diagram showing examples of combinations in the layout of the catalyst and the adsorption catalyst.

FIG. 11 is a graph showing the results of measuring the average proportion converted in the examples of the combinations of FIG. 10.

### DESCRIPTION OF PREFERRED EMBODIMENTS

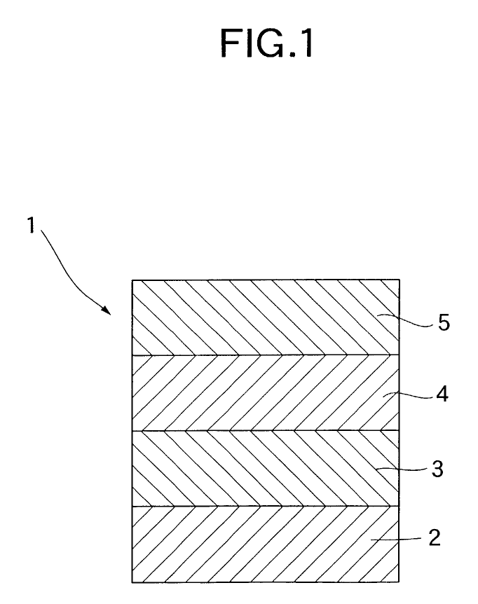

Firstly, referring to FIG. 1, an adsorption catalyst 1 that adsorbs HCs at low temperature when an internal combustion engine is started and converts the HCs desorbed at high temperature is formed by supporting on a honeycomb support 2, and comprises an adsorbent layer 3, an inorganic material layer 4, and a catalytic layer 5. The adsorbent layer 3 is formed by layering on the surface of the support 2 an adsorbent that adsorbs hydrocarbons contained in an exhaust gas. The inorganic material layer 4 is formed by layering on top of the adsorbent layer 3 an inorganic material containing no precious metal. The catalytic layer 5 is formed by layering on top of the inorganic material layer 4 a catalyst that converts the hydrocarbons desorbed from the adsorbent.

The adsorption catalyst layer 3 is now explained in detail below by reference to Embodiments and Comparative Examples.

Embodiment 1; 100 parts by weight of a Cs-ZSM-5 zeolite powder obtained by subjecting a ZSM-5 zeolite which is of the MFI type to ion exchange with Cs at an ion-exchange proportion of 95%, 50 parts by weight of a silica sol, and 110 parts by weight of pure water were mixed by grinding in a ball mill for 12 hours. A 1 inch diameter, 60 mm long, 300 cell, 10.5 mil cordierite honeycomb support was immersed in the thus-obtained slurry, followed by calcining to coat the support with the adsorbent at 100 g/L.

Embodiment 2; 100 parts by weight of a Cs-β-type zeolite powder obtained by subjecting a β-type zeolite to ion exchange with Cs at an ion-exchange proportion of 100%, 50 parts by weight of a silica sol, and 180 parts by weight of pure water were mixed by grinding in a ball mill for 12 hours. A 1 inch diameter, 60 mm long, 300 cell, 10.5 mil cordierite honeycomb support was immersed in the thus-obtained slurry, followed by calcining to coat the support with the adsorbent at 100 g/L.

Embodiment 3; 100 parts by weight of the Cs-ZSM-5 zeolite powder obtained in Embodiment 1, 50 parts by weight of a silica sol, and 110 parts by weight of pure water were mixed by grinding in a ball mill for 12 hours. A 1 inch diameter, 60 mm long, 300 cell, 10.5 mil cordierite honeycomb support was immersed in the thus-obtained slurry, followed by calcining to coat the support with the adsorbent at 50 g/L. After this, 100 parts by weight of a β-type zeolite powder having an SiO₂/Al₂O₃ in ratio of 1700, 50 parts by weight of a silica sol, and 180 parts by weight of pure water were mixed by grinding in a ball mill for 12 hours, and the above support was immersed in the thus-obtained slurry, followed by calcining to coat the upper layer of the adsorbent containing the Cs-ZSM-5 zeolite with the adsorbent containing the β-type zeolite at 50 g/L, thereby layering a total of 100 g/L of the adsorbents on the support. Furthermore, 100 parts by weight of Pd(NO₃)₂.nH₂O (palladium nitrate) which was used as the catalyst, 100 parts by weight of Al₂O₃ powder, 50 parts by weight of a silica sol, and 400 parts by weight of pure water were mixed by grinding in a ball mill for 12 hours, and the above support was immersed in the thus-obtained slurry, followed by calcining, thereby layering 40 g/L of the catalyst on the total of 100 g/L of the adsorbents.

Embodiment 4; 100 parts by weight of the Cs-ZSM-5 zeolite powder obtained in Embodiment 1, 50 parts by weight of a silica sol, and 110 parts by weight of pure water were mixed by grinding in a ball mill for 12 hours. A 1 inch diameter, 60 mm long, 300 cell, 10.5 mil cordierite honeycomb support was immersed in the thus-obtained slurry, followed by calcining to coat the support with the adsorbent at 80 g/L. After this, 100 parts by weight of a β-type zeolite powder having an SiO₂/Al₂O₃ in ratio of 1700, 50 parts by weight of a silica sol, and 180 parts by weight of pure water were mixed by grinding in a ball mill for 12 hours, and the above support was immersed in the thus-obtained slurry, followed by calcining to coat the upper layer of the adsorbent containing the Cs-ZSM-5 zeolite with the adsorbent containing the β-type zeolite at 20 g/L, thereby layering a total of 100 g/L of the adsorbents on the support. Furthermore, 100 parts by weight of Pd(NO₃)₂.nH₂O, 100 parts by weight of Al₂O₃ powder, 50 parts by weight of a silica sol, and 400 parts by weight of pure water were mixed by grinding in a ball mill for 12 hours, and the above support was immersed in the thus-obtained slurry, followed by calcining, thereby layering 40 g/L of the catalyst on the total of 100 g/L of the adsorbents.

Embodiment 5; 100 parts by weight of the Cs-ZSM-5 zeolite powder obtained in Embodiment 1, 50 parts by weight of a silica sol, and 110 parts by weight of pure water were mixed by grinding in a ball mill for 12 hours. A 1 inch diameter, 60 mm long, 300 cell, 10.5 mil cordierite honeycomb support was immersed in the thus-obtained slurry, followed by calcining to coat the support with the adsorbent at 60 g/L. After this, 100 parts by weight of a β-type zeolite powder having an SiO₂/Al₂O₃ in ratio of 1700, 50 parts by weight of a silica sol, and 180 parts by weight of pure water were mixed by grinding in a ball mill for 12 hours, and the above support was immersed in the thus-obtained slurry, followed by calcining to coat the upper layer of the adsorbent containing the Cs-ZSM-5 zeolite with the adsorbent containing the β-type zeolite at 40 g/L, thereby layering a total of 100 g/L of the adsorbents on the support. Furthermore, 100 parts by weight of Pd(NO₃)₂.nH₂O, 100 parts by weight of Al₂O₃ powder, 50 parts by weight of a silica sol, and 400 parts by weight of pure water were mixed by grinding in a ball mill for 12 hours, and the above support was immersed in the thus-obtained slurry, followed by calcining, thereby layering 40 g/L of the catalyst on the total of 100 g/L of the adsorbents.

Embodiment 6; 100 parts by weight of the Cs-ZSM-5 zeolite powder obtained in Embodiment 1, 50 parts by weight of a silica sol, and 110 parts by weight of pure water were mixed by grinding in a ball mill for 12 hours. A 1 inch diameter, 60 mm long, 300 cell, 10.5 mil cordierite honeycomb support was immersed in the thus-obtained slurry, followed by calcining to coat the support with the adsorbent at 40 g/L. After this, 100 parts by weight of a β-type zeolite powder having an SiO₂/Al₂O₃ in ratio of 1700, 50 parts by weight of a silica sol, and 180 parts by weight of pure water were mixed by grinding in a ball mill for 12 hours, and the above support was immersed in the thus-obtained slurry, followed by calcining to coat the upper layer of the adsorbent containing the Cs-ZSM-5 zeolite with the adsorbent containing the β-type zeolite at 60 g/L, thereby layering a total of 100 g/L of the adsorbents on the support. Furthermore, 100 parts by weight of Pd(NO₃)₂.nH₂O, 100 parts by weight of Al₂O₃ powder, 50 parts by weight of a silica sol, and 400 parts by weight of pure water were mixed by grinding in a ball mill for 12 hours, and the above support was immersed in the thus-obtained slurry, followed by calcining, thereby layering 40 g/L of the catalyst on the total of 100 g/L of the adsorbents.

Embodiment 7; 100 parts by weight of the Cs-ZSM-5 zeolite powder obtained in Embodiment 1, 50 parts by weight of a silica sol, and 110 parts by weight of pure water were mixed by grinding in a ball mill for 12 hours. A 1 inch diameter, 60 mm long, 300 cell, 10.5 mil cordierite honeycomb support was immersed in the thus-obtained slurry, followed by calcining to coat the support with the adsorbent at 20 g/L. After this, 100 parts by weight of a β-type zeolite powder having an SiO₂/Al₂O₃ in ratio of 1700, 50 parts by weight of a silica sol, and 180 parts by weight of pure water were mixed by grinding in a ball mill for 12 hours, and the above support was immersed in the thus-obtained slurry, followed by calcining to coat the upper layer of the adsorbent containing the Cs-ZSM-5 zeolite with the adsorbent containing the β-type zeolite at 80 g/L, thereby layering a total of 100 g/L of the adsorbents on the support. Furthermore, 100 parts by weight of Pd(NO₃)₂.nH₂O, 100 parts by weight of Al₂O₃ powder, 50 parts by weight of a silica sol, and 400 parts by weight of pure water were mixed by grinding in a ball mill for 12 hours, and the above support was immersed in the thus-obtained slurry, followed by calcining, thereby layering 40 g/L of the catalyst on the total of 100 g/L of the adsorbents.

Comparative Example 1; 100 parts by weight of a β-type zeolite powder having an SiO₂/Al₂O₃ in ratio of 1700, 50 parts by weight of a silica sol, and 200 parts by weight of pure water were mixed by grinding in a ball mill for 12 hours, and a 1 inch diameter, 60 mm long, 300 cells 10.5 mil cordierite honeycomb support was immersed in the thus-obtained slurry, followed by calcining to coat the support with the adsorbent at 100 g/L.

Comparative Example 2; 100 parts by weight of a mordenite-type zeolite powder having an SiO₂/Al₂O₃ in ratio of 240, 50 parts by weight of a silica sol, and 180 parts by weight of pure water were mixed by grinding in a ball mill for 12 hours, and a 1 inch diameter, 60 mm long, 300 cell, 10.5 mil cordierite honeycomb support was immersed in the thus-obtained slurry, followed by calcining to coat the support with the adsorbent at 100 g/L.

Comparative Example 3; 100 parts by weight of a ZSM-5-type zeolite powder having an SiO₂/Al₂O₃ in ratio of 750, 50 parts by weight of a silica sol, and 110 parts by weight of pure water were mixed by grinding in a ball mill for 12 hours, and a 1 inch diameter, 60 mm long, 300 cell, 10.5 mil cordierite honeycomb support was immersed in the thus-obtained slurry, followed by calcining to coat the support with the adsorbent at 100 g/L.

Comparative Example 4; 100 parts by weight of a ferrierite-type zeolite powder having an SiO₂/Al₂O₃ in ratio of 93, 50 parts by weight of a silica sol, and 240 parts by weight of pure water were mixed by grinding in a ball mill for 12 hours, and a 1 inch diameter, 60 mm long, 300 cell, 10.5 mil cordierite honeycomb support was immersed in the thus-obtained slurry, followed by calcining to coat the support with the adsorbent at 100 g/L.

Comparative Example 5; 100 parts by weight of a USY-type zeolite powder having an SiO₂/Al₂O₃ in ratio of 390, 50 parts by weight of a silica sol, and 190 parts by weight of pure water were mixed by grinding in a ball mill for 12 hours, and a 1 inch diameter, 60 mm long, 300 cell, 10.5 mil cordierite honeycomb support was immersed in the thus-obtained slurry, followed by calcining to coat the support with the adsorbent at 100 g/L.

Comparative Example 6; 50 parts by weight of the Cs-ZSM-5 zeolite powder obtained in Embodiment 1, 50 parts by weight of a β-type zeolite powder having an SiO₂/Al₂O₃ in ratio of 1700, 50 parts by weight of a silica sol, and 145 parts by weight of pure water were mixed by grinding in a ball mill for 12 hours, and a 1 inch diameter, 60 mm long, 300 cell, 10.5 mil cordierite honeycomb support was immersed in the thus-obtained slurry, followed by calcining to coat the support with a total of 100 g/L of the adsorbents including 50 g/L each of the adsorbent containing the Cs-ZSM-5 zeolite and the adsorbent containing the β-type zeolite. Furthermore, 100 parts by weight of Pd(NO₃)₂.nH₂O, 100 parts by weight of Al₂O₃ powder, 50 parts by weight of a silica sol, and 400 parts by weight of pure water were mixed by grinding in a ball mill for 12 hours, and the above support was immersed in the thus-obtained slurry, followed by calcining, thereby layering 40 g/L of the catalyst on the total of 100 g/L of the adsorbents.

Various evaluation tests were then carried out using various types of zeolites and the adsorption catalysts of Embodiments 1 to 7 and Comparative Examples 1 to 6, and the results are explained below; aging in each of the tests was carried out in a furnace tube at 900° C. for 20 hours while maintaining the atmosphere at 1% O₂, 10% H₂O, and 89% N₂. The measurement conditions were as shown in Table 1.

TABLE 1
Model Gas Evaluation Conditions

| | |
|---|---|
| Evaluation equipment: | atmospheric pressure fixed |
| | circulation system |
| Catalyst volume: | 0.03 L |
| Gas composition: | |
| HC: | 600 ppm C |
| CO₂: | 14% |
| O₂: | 0.5% |
| CO: | 0.5% |
| NO: | 500 ppm |
| H₂: | 0.17% |
| H₂O: | 10% |
| N₂: | remainder |
| Gas flow rate: | 25 L/min |
| Measurement temperature: | 50° C. to 100° C. |
| Rate of increase: | 20° C./min |

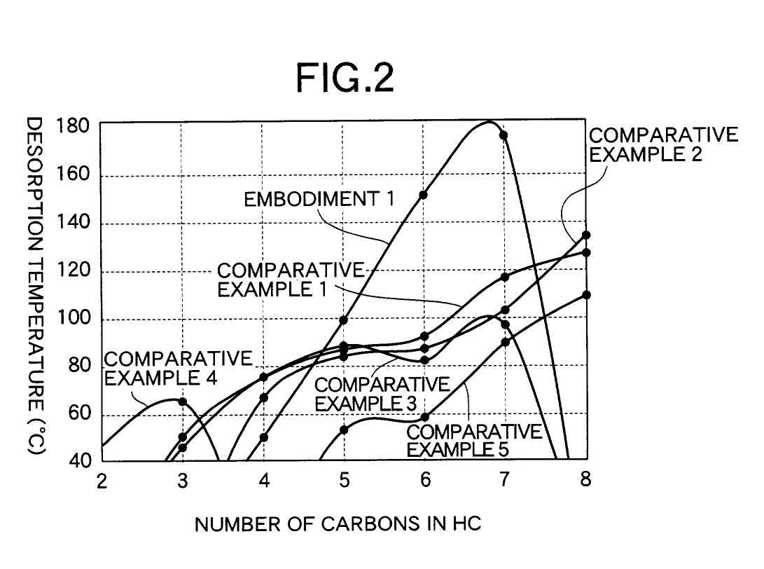

An adsorption/desorption start test was carried out under the measurement conditions shown in Table 1 above on Embodiment 1 and Comparative Examples 1 to 5 using an HC gas containing ethane (C₂H₆), propylene (C₃H₆), butane (C₄H₁₀), 1-pentene (C₅H₁₀), benzene (C₆H₆), toluene (C₇H₈), m-xylene (C₈H₁₀), and 2,2,4-trimethylpentane (C₈H₁₈), and the results are shown in FIG. 2.

Referring to FIG. 2, as shown by all the zeolites except the Cs-ZSM-5 zeolite of Embodiment 1, that is, the β-type zeolite of Comparative Example 1, the mordenite type zeolite of Comparative Example 2, the MFI-type zeolite of Comparative Example 3, the ferrierite type zeolite of Comparative Example 4, and the USY-type zeolite of Comparative Example 5, it was found that zeolites having a small pore size easily adsorb low molecular weight HCs and are suitable for the adsorption of low molecular HCs because of their high desorption start temperatures, zeolites having a large pore size easily adsorb high molecular weight HCs and are suitable for the adsorption of high molecular weight HCs because of their high desorption start temperatures, and the adsorption of HCs was substantially proportional to the molecular weight of the HCs. Since the Cs-ZSM-5 zeolite of Embodiment 1 showed higher desorption start temperatures for HCs having 5 to 7 carbons (C5 to C7) than those of all the zeolites of the Comparative Examples above, it is surmised that all the zeolites of the Comparative Examples above exhibit physical adsorption, whereas the Cs-ZSM-5 zeolite of Embodiment 1 exhibits chemical adsorption.

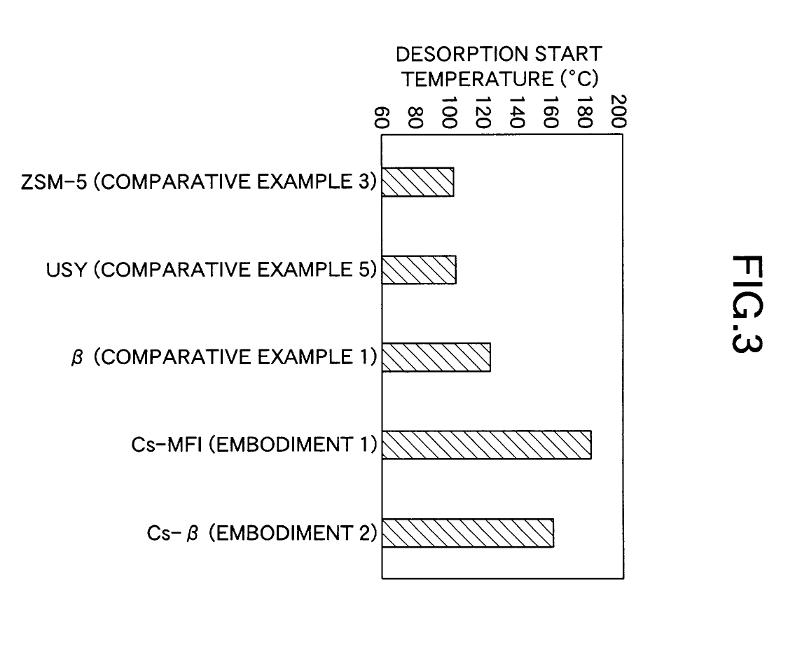

Next, an adsorption/desorption test was carried out under the measurement conditions shown in Table 1 above on Embodiments 1 and 2 and Comparative Examples 1, 3, and 5 using a gaseous mixture of 8 types of HCs having the composition shown in Table 2 as a simulated exhaust gas for the exhaust gas of an actual vehicle, and the results are shown in FIG. 3.

TABLE 2
Measured hydrocarbon type

| | Concentration | |
|---|---|---|
| Mixture of 8 types of HCs | (ppm C) | Percentage |
| Ethane (C₂H₆) | 60 | 10% |
| Propylene (C₃H₆) | 39 | 7% |
| 1-Butene (C₄H₈) | 33 | 6% |
| MTBE (C₅H₁₂O) | 54 | 9% |
| Benzene (C₆H₆) | 61 | 10% |
| Toluene (C₇H₈) | 205 | 34% |
| m,p-xylene (C₈H₁₀) | 43 | 7% |
| 2,2,4-trimethylpentane (C₈H₁₈) | 105 | 18% |
| TOTAL | 600 | 100% |

As is clear from FIG. 3, the Cs-ZSM-5 zeolite and the Cs-β-type zeolite on which Cs is supported have higher desorption start temperatures than those of the β-type zeolite, the MFI-type zeolite, and the USY-type zeolite.

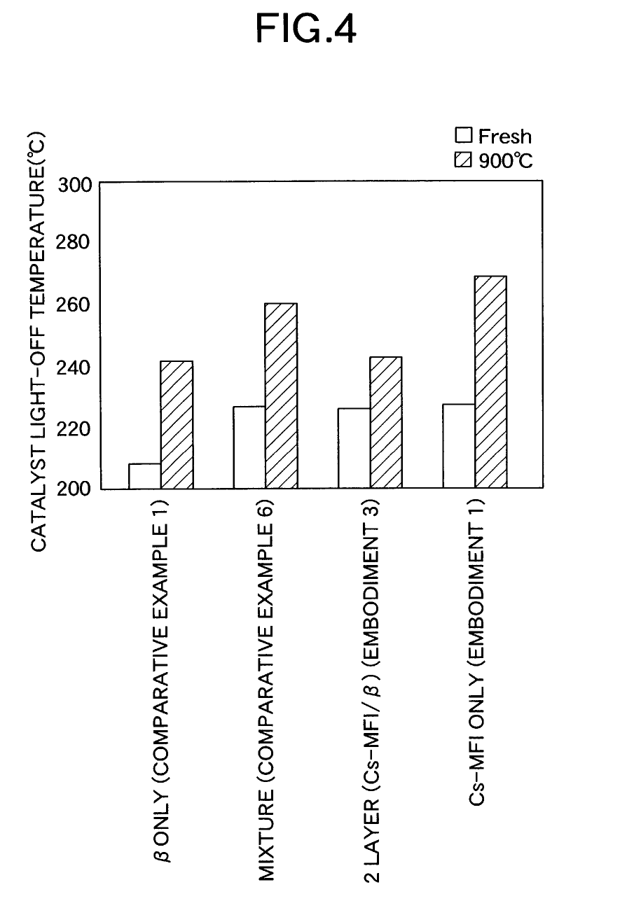

The temperature at which the conversion of HCs by the catalyst reached 50% (light-off temperature) was measured under the measurement conditions shown in Table 1 above for Embodiments 1 and 3 and Comparative Examples 1 and 6, and the results are shown in FIG. 4.

As is clear from FIG. 4, in a fresh state the adsorption catalyst (Comparative Example 1) in which the catalyst was supported on the β-type zeolite had a low light-off temperature and high catalytic activity, but all the types containing the Cs-MFI-type zeolite (Embodiments 1 and 6 and Comparative Example 3) had almost the same light-off temperatures, and this is due to the light-off temperature appearing to increase because the HC desorption start temperature is high.

When aging was carried out at 900° C., although the catalyst had deteriorated, the light-off temperature was about 242° C. in the case (Comparative Example 1) where the adsorbent was the β-type zeolite alone, and in the case (Embodiment 3) where the lower layer was the Cs-MFI-type zeolite, the middle layer was the β-type zeolite, and the upper layer was the catalyst, whereas the light-off temperature was 260° C. or higher in the case (Embodiment 1) where the adsorbent was the Cs-MFI-type zeolite alone, and in the case (Comparative Example 6) where the adsorbent was the mixture of the Cs-MFI type and β-type zeolites, suggesting that the catalyst had greatly deteriorated. It can be surmised from these results that in the zeolite on which Cs was supported by ion exchange the catalyst reacted with the Cs during the aging, and the catalyst thus deteriorated. The Cs-supporting zeolite in contact with the catalyst causes deterioration of the catalyst, and it is therefore necessary to place the catalyst and the Cs-supporting zeolite apart so that they are not in contact with each other. In this way, it is possible to suppress deterioration of the catalyst and maintain the HC adsorption/desorption conversion functions, and it is therefore desirable to place the inorganic material layer 4, which is an inorganic material containing no catalytic precious metal, between the adsorbent layer 3 and the catalytic layer 5.

With regard to the inorganic material, it can be selected from oxides such as zeolites containing no Cs, ceria, and alumina, but selecting a zeolite having high physical adsorption capability can provide high adsorptivity by the inorganic material during an initial period of adsorption; and hold HCs by the Cs-supporting zeolite which has retentivity at high temperature, during a middle to final period of adsorption, thereby obtaining an adsorbent having overall high adsorptivity together with high adsorption retentivity.

The zeolite on which Cs is supported is required to have heat resistance, and the heat resistance of a zeolite having a low silica/alumina ratio, that is, a high Al content, is generally low. On the other hand, in order to ensure the ion exchangeability of the Cs, it is preferable to use a zeolite having a high Al content, and when selecting a zeolite in view of these mutually contradictory requirements, a ZSM-5 zeolite, which is of the MFI type, has the characteristics of a low silica/alumina ratio, that is, a high Al content, and an excellent heat resistance. It is therefore preferable to use a ZSM-5 zeolite as the zeolite for supporting the Cs, but HCs having large molecular sizes such as 2,2,4-trimethylpentane and m-xylene do not match the pore size of the MFI-type zeolite. It is therefore desirable to form the inorganic material layer using a zeolite such as a β-type zeolite, which has a pore size that can adsorb HCs having large molecular sizes.

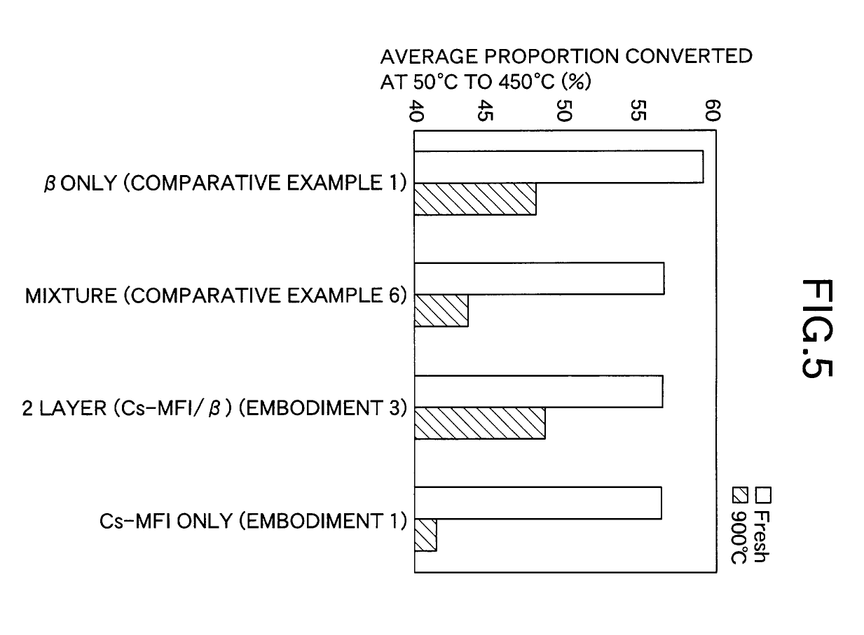

The average proportion converted at 50° C. to 450° C. was measured under the measurement conditions shown in Table 1 above for Embodiments 1 and 3 and Comparative Examples 1 and 6, and the results are shown in FIG. 5.

As is clear from FIG. 5, in a fresh state the adsorption catalyst (Comparative Example 1) in which the catalyst was supported on the β-type zeolite could adsorb many types of HCs, had a low light-off temperature and a high catalytic activity, resulting in an excellent adsorption conversion performance. On the other hand, after aging at 900° C., that (Embodiment 1) in which the adsorbent was the Cs-MFI-type zeolite alone, that (Comparative Example 1) in which the adsorbent was the β-type zeolite alone, and that (Comparative Example 6) in which the adsorbent was the mixture of the Cs-MFI-type and β-type zeolites had a low average proportion converted due to a decrease in the light-off temperature as described above, whereas that (Embodiment 3) in which the lower layer was the Cs-MFI-type zeolite, the middle layer was the β-type zeolite, and the upper layer was the catalyst could adsorb many types of HCs due to the β-type zeolite, had excellent high temperature desorption performance due to the Cs-MFI-type zeolite, and could prevent contact between Cs and the catalyst, thereby exhibiting an excellent adsorption conversion performance.

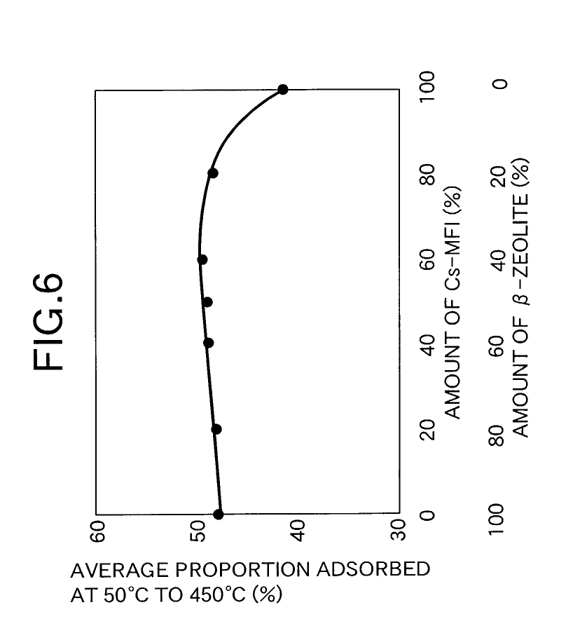

The change in average proportion adsorbed at 50° C. to 450° C. in response to change in the zeolite in ratio of the Cs-MFI-type zeolite in the adsorbent layer 3 to the β-type zeolite in the inorganic material layer 4, was measured under the measurement conditions shown in Table 1 above using Embodiments 3 to 7, and the results are shown in FIG. 6.

As is clear from FIG. 6, the average proportion converted decreases regardless of whether the amount of Cs-MFI-type zeolite supported is large or small. This is because when the proportion of β-type zeolite is high, although the initial adsorptivity is high, the desorption temperature is low, and when the amount of Cs-MFI-type zeolite supported is large, HCs having large molecular sizes such as 2,2,4-trimethylpentane cannot be captured, thereby degrading the initial adsorptivity.

It can be said from these results that, if the proportion of the Cs-MFI-type zeolite in the zeolites is 30% to 80%, it is more effective than in the case where each zeolite is used individually, and a proportion of 50% to 75% shows a better effect.

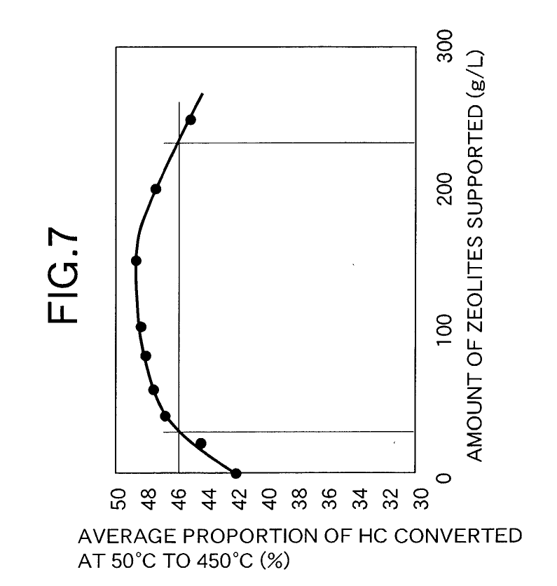

The change in average proportion converted at 50° C. to 450° C. in response to change in the total amount of the zeolites including the Cs-MFI-type zeolite in the adsorbent layer 3 and the β-type zeolite in the inorganic material layer 4, was measured under the measurement conditions shown in Table 1 above using Embodiments 3 to 7, and the results are shown in FIG. 7.

As is clear from FIG. 7, the average proportion converted decreases regardless of whether the amount of zeolite is large or small. This is because when the amount of zeolites supported is small, the amount of HCs that can adsorb thereon decreases, and when the amount of zeolites supported is large, the amount of adsorbed HCs in proportion to the amount of zeolites decreases, and as a result the adsorption efficiency of the Cs-MFI-type zeolite decreases. It can be said from these results that, when the zeolites are present at 20 to 270 g/L, it is more effective than in the case where there is no adsorbent (0 g/L), and an amount of 80 to 180 g/L shows a better effect.

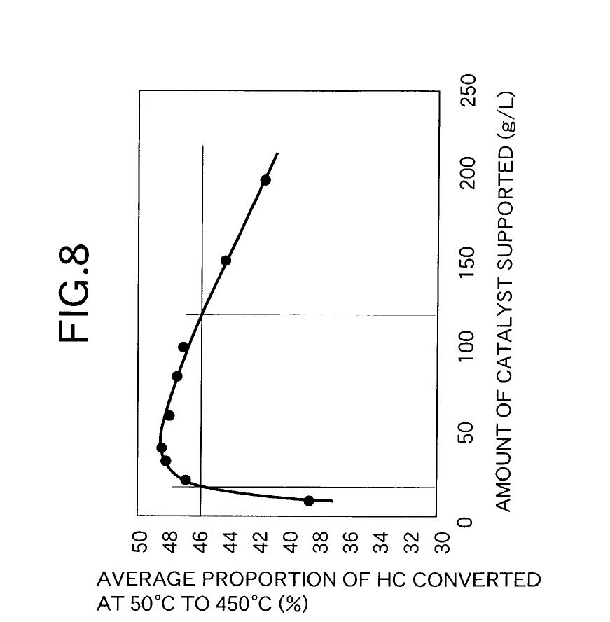

The change in average proportion converted at 50° C. to 450° C. in response to change in the amount of catalyst supported, was measured under the measurement conditions shown in Table 1 above using Embodiments 3 to 7, and the results are shown in FIG. 8.

As is clear from FIG. 8, the average proportion converted decreases regardless of whether the amount of catalyst supported is large or small. This is because when the amount of catalyst supported is small, the proportion of precious metal in the catalyst increases and consequently sintering of the precious metal due to the aging intensifies, thereby degrading the catalytic performance, and when the amount of catalyst supported is large, the increase in temperature of the catalyst is delayed due to the increase in heat capacity. The amount of catalyst supported that can suppress deterioration of the catalyst and an increase in the heat capacity is therefore 10 to 160 g/L, and more preferably 15 to 120 g/L.

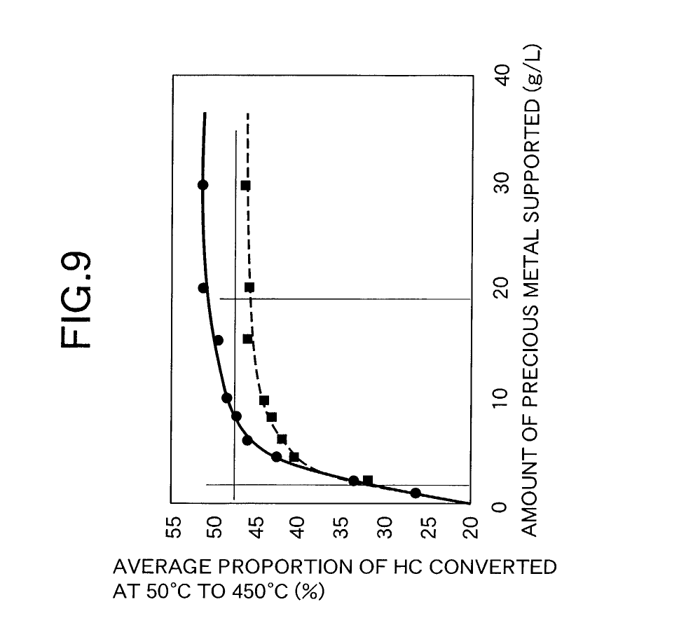

The change in average proportion converted at 50° C. to 450° C. when changing the amount of precious metal in the catalyst, was measured under the measurement conditions shown in Table 1 above for Embodiments 3 to 7, and the results are shown by the solid curve in FIG. 9. The change in average proportion converted at 50° C. to 450° C. when changing the amount of precious metal in the case where the catalyst alone, was used without any adsorbent was measured under the measurement conditions shown in Table 1 above, and the results are shown by the broken curve in FIG. 9.

As is clear from FIG. 9, in both cases the average proportion converted increased in response to an increase in the amount of precious metal, but in the case where there was an adsorbent, the average proportion converted was enhanced compared with the case where no adsorbent was present when the amount of precious metal was 1 g/L or more. This is because, in order to convert HCs adsorbed on the adsorbent, the catalyst is required to be activated at a low temperature, and when the amount of precious metal is small the effect cannot be exhibited adequately. The amount of precious metal in the catalyst is therefore at least 1 g/L; when there is too much the cost effectiveness decreases, and 3 to 15 g/L is effective.

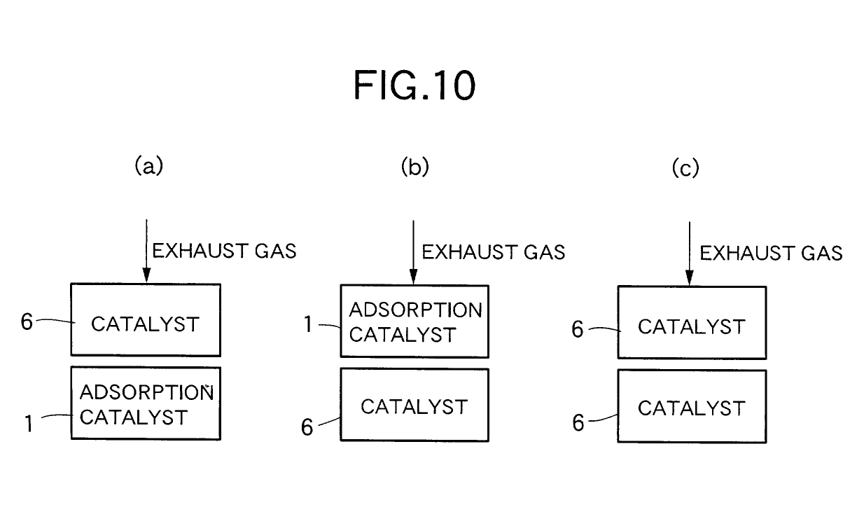

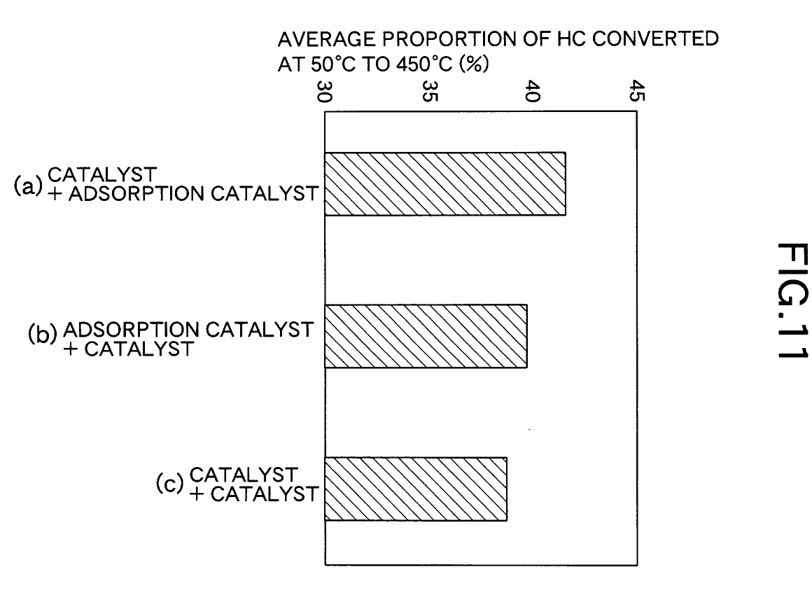

Next, as shown in FIG. 10, the average proportion converted was measured at 50° C. to 450° C. under the measurement conditions shown in Table 3 using the HC gas shown in Table 2 above for case (a) in which a catalyst 6 was disposed on the upstream side of the adsorption catalyst 1, case (b) in which the catalyst 6 was disposed on the downstream side of the adsorption catalyst 1, and case (c) in which the catalysts 6, 6 were disposed in series without using the adsorption catalyst 1, and the results are shown in FIG. 11.

TABLE 3
Model Gas Evaluation Conditions

| | |
|---|---|
| Evaluation equipment: | atmospheric pressure fixed |
| | circulation system |
| Catalyst volume: | 0.03 L |
| Gas composition: | |
| HC: | 600 ppm C |
| CO₂: | 14% |
| O₂: | 0.5% |
| CO: | 0.5% |
| NO: | 500 ppm |
| H₂: | 0.17% |
| H₂O: | 10% |
| N₂: | remainder |
| Gas flow rate: | 25 L/min |
| Measurement temperature: | 50 to 100° C. |
| Rate of increase: | 80° C./min |

As is clear from FIG. 11, it was found that the average proportion converted was higher for the case in which the catalyst 6 was placed on the upstream side of the adsorption catalyst 1 than for the other cases. The reason is as follows: since the purification activity of the adsorption catalyst 1 is delayed due to the heat capacity of the adsorbent in comparison with the case where the catalysts 6, 6 alone were used, by placing the catalyst 6 having a low heat capacity in the first stage, HCs in the exhaust gas that is cooled due to the catalyst 6 in the first stage being in an inactivated state so as to have a comparatively low temperature can be adsorbed effectively by the adsorption catalyst 1 in the second stage, and after the catalyst 6 in the first stage is activated the reaction thereon can rapidly increase the temperature of the exhaust gas that is to be introduced into the adsorption catalyst 1 in the second stage, thereby heating the adsorption catalyst 1. That is, placing the adsorption catalyst 1 having adsorption and purification effects on the downstream side of the catalyst 6 can thus give an excellent average proportion converted.

Although embodiments of the present invention are explained above, the present invention is not limited by the above-mentioned embodiments and can be modified in a variety of ways without departing from the present invention described in the scope of claims.

In the embodiments, an explanation is given to an exhaust gas purification device employing the HC adsorption catalyst method in which HCs are adsorbed by the adsorbent in a low temperature state when an internal combustion engine is started, and when the HCs are desorbed from the adsorbent at high temperature they are converted by the catalyst present on the same support. However, the present invention may be applied to, for example, an exhaust gas purification device employing the bypass switchover method in which the exhaust gas is made to flow to the adsorbent side by a bypass valve when an internal combustion engine is started, and the bypass valve is switched over so as to make the exhaust gas flow to the catalyst side before the HCs are desorbed from the adsorbent.

What is claimed is:

1. An internal combustion engine exhaust gas purification device comprising:
an adsorbent that adsorbs hydrocarbons contained in an exhaust gas from an internal combustion engine; and
a catalyst that converts the hydrocarbons desorbed from the adsorbent;
wherein the adsorbent contains a zeolite on which Cs is supported.

2. The internal combustion engine exhaust gas purification device according to claim 1, wherein the adsorbent and the catalyst are disposed so that they are not in contact with each other.

3. An internal combustion engine exhaust gas purification device comprising:
a support;
an adsorbent layer formed by layering on the surface of the support an adsorbent for adsorbing hydrocarbons contained in an exhaust gas from an internal combustion engine;
an inorganic material layer formed by layering on top of the adsorbent layer an inorganic material containing no precious metal; and
a catalytic layer formed by layering on top of the inorganic material layer a catalyst for converting the hydrocarbons desorbed from the adsorbent;
wherein the adsorbent contains a zeolite on which Cs is supported.

4. The internal combustion engine exhaust gas purification device according to claim 3, wherein the zeolite is an MFI-type zeolite.

5. The internal combustion engine exhaust gas purification device according to claim 4, wherein the inorganic material comprises at least one material chosen from among a β-type zeolite, a Y-type zeolite, and a mordenite type zeolite.

6. The internal combustion engine exhaust gas purification device according to claim 5, wherein the catalyst is formed by supporting a precious metal on an inorganic oxide.
